(19) United States
(12) Patent Application Publication
(10) Pub. No.: US 2024/0273690 A1
(43) Pub. Date: Aug. 15, 2024

(54) SYSTEMS AND METHODS FOR PURPLE FRINGE CORRECTION

(71) Applicant: Meta Platforms Technologies, LLC, Menlo Park, CA (US)

(72) Inventors: Touraj Tajbakhsh, Carson City, NV (US); Anatoly Litvinov, Binyamina (IL); Ben Yosef Weiss, Tel Aviv (IL)

(21) Appl. No.: 18/438,052

(22) Filed: Feb. 9, 2024

Related U.S. Application Data
(60) Provisional application No. 63/484,165, filed on Feb. 9, 2023.

(51) Int. Cl. G06T 5/80; G06T 7/90

(52) U.S. Cl. CPC G06T 5/80; G06T 7/90

(57) ABSTRACT

A disclosed computer-implemented method may include detecting, within an image processing pipeline, based on a multifactor pixel-level analysis of image data processed by the image processing pipeline, that the image data includes at least one purple fringe artifact. The method may also include dynamically adjusting, within the image processing pipeline and based on a calculated confidence level that blends between different correction methods, the image data to reduce a visual impact of the at least one purple fringe artifact. Various other methods, systems, and devices are also disclosed.

### CROSS-REFERENCE TO RELATED APPLICATION

This application claims the benefit of U.S. Provisional Patent Application No. 63/484,165, filed Feb. 9, 2023 (the “Provisional Application”), the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for purple fringe correction.

FIG. 2 is a block diagram of an example implementation of a system for purple fringe correction.

FIG. 3 is a flow diagram of an example method for purple fringe correction.

FIG. 4 is an illustration of an operational flow diagram that shows some of the operational steps that embodiments of the systems and methods disclosed herein may execute to detect purple fringe artifacts in image data.

FIG. 5 is an illustration of an operational flow diagram that shows some of the operational steps that embodiments of the systems and methods disclosed herein may execute for the correction of purple fringe artifacts in image data.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

FIG. 8 is an illustration of exemplary haptic devices that may be used in connection with embodiments of this disclosure.

FIG. 9 is an illustration of an exemplary virtual-reality environment according to embodiments of this disclosure.

FIG. 10 is an illustration of an exemplary augmented-reality environment according to embodiments of this disclosure.

FIG. 11 an illustration of an exemplary system that incorporates an eye-tracking subsystem capable of tracking a user's eye(s).

FIG. 12 is a more detailed illustration of various aspects of the eye-tracking subsystem illustrated in FIG. 11.

FIGS. 13A and 13B are illustrations of an exemplary human-machine interface configured to be worn around a user's lower arm or wrist.

FIGS. 14A and 14B are illustrations of an exemplary schematic diagram with internal components of a wearable system.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Chromatic aberrations are a type of distortion that can occur in digital images as a result of the way that lenses refract light. They appear as purple, blue, or red fringes along the edges of high-contrast objects in an image and are caused by the lens failing to focus all colors of light to the same point on the sensor.

There are several factors that can contribute to the occurrence of chromatic aberrations, including the quality and design of the lens, the aperture setting, and the type of light source. Chromatic aberrations are more likely to occur at the edges of the frame and are more pronounced when using a lens with a wide aperture. Purple fringes can also originate from the image sensor array when charge cross-talk between neighboring pixels generate a mixing between the color channels. Another contribution to the creation of purple fringes includes the processing steps in an image signal processing (ISP) pipeline such as demosaicing or binning.

Traditional methods for correcting purple fringing involve manual post-processing techniques or simple automated adjustments that do not account for the multifaceted nature of the artifact. These approaches often result in suboptimal correction, affecting the natural appearance of images or failing to remove the artifact entirely.

Moreover, existing image processing systems often address purple fringing as a secondary concern, focusing primarily on general color correction or sharpness enhancements. As a result, there is a need for an advanced image processing solution that specifically targets purple fringe artifacts, employing a comprehensive analysis of image data to dynamically adjust and correct these artifacts without compromising overall image quality.

The present disclosure is generally directed to systems and methods for purple fringe correction. As will be explained in greater detail below, embodiments of the instant disclosure may detect, within an image processing pipeline, based on a multifactor pixel-level analysis of image data processed by the image processing pipeline, that the image data includes at least one purple fringe artifact. Embodiments of the instant disclosure may further dynamically adjust, within the image processing pipeline and based on a calculated confidence level that blends between different correction methods, the image data to reduce a visual impact of the at least one purple fringe artifact.

By integrating these features into an image processing pipeline, the embodiments of the systems and methods described herein offer a targeted and efficient solution for enhancing image quality in digital images and other applications requiring high-fidelity image processing. For example, in some embodiments, the systems and methods disclosed herein may be implemented within an image processing pipeline of an artificial reality (AR) and/or virtual reality (VR) headset, thereby improving image quality of images displayed to users via one or more display devices included therein.

The systems and methods disclosed herein represent a significant advancement over prior art by providing a dedicated and automated solution for purple fringe correction that is both effective and efficient, preserving the integrity of the original image while significantly reducing the time and effort required for post-processing corrections.

In some examples, a “purple fringe artifact” may include or refer to an optical aberration commonly observed in digital images, manifesting as purple or magenta-colored halos or outlines along the edges of high-contrast areas. This artifact may result primarily from axial chromatic aberration, where different wavelengths of light, specifically the blue and red ends of the visible spectrum, are focused at different points by a lens, failing to converge at the sensor plane. Consequently, the defocused light creates a fringe effect around objects, especially noticeable where bright light sources or reflections abut darker regions. Additionally, purple fringe artifacts may be exacerbated by sensor-related phenomena, including pixel intensity saturation or blooming, where excessive light intensity causes electrons to overflow from saturated pixels to adjacent, unsaturated pixels, further contributing to the visibility of purple fringing. The term encompasses both the visual manifestation of this optical phenomenon in digital imaging and the underlying causes contributing to its occurrence.

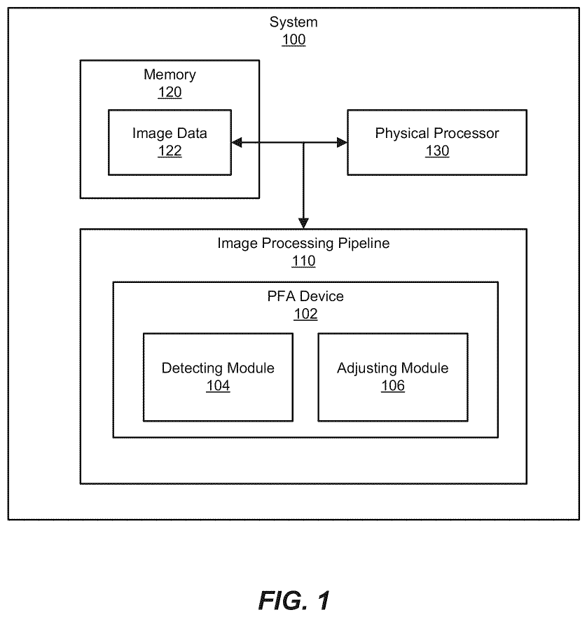

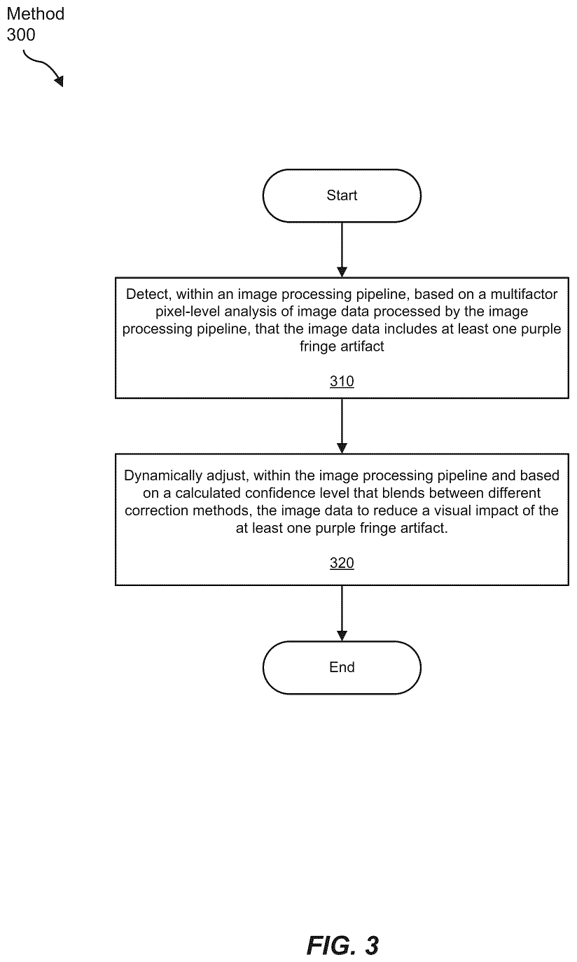

The following will provide, with reference to FIGS. 1-2 and 4-14B, detailed descriptions of systems for purple fringe detection, adjustment, and/or correction. Detailed descriptions of corresponding computer-implemented methods will also be provided in connection with FIG. 3.

FIG. 1 is a block diagram of an example system 100 for purple fringe correction. As illustrated in this figure, example system 100 may include a purple fringe adjustment (PFA) device 102 that includes one or more modules for performing one or more tasks. as will be explained in greater detail below, the modules may include a detecting module 104 that detects, based on a multifactor pixel-level analysis of the image data, that the image data includes at least one purple fringe artifact, and an adjusting module 106 that dynamically adjusts, based on a calculated confidence level that blends between different correction methods, the image data to reduce a visual impact of the at least one purple fringe artifact.

As shown in FIG. 1, PFA device 102 may be included in an image processing pipeline 110. An “image processing pipeline” may include or refer to a systematic sequence of operations or stages through which digital image data is processed to enhance its quality, correct artifacts, and prepare it for display or analysis. This pipeline may include a series of software and/or hardware modules, each designed to perform specific tasks on the image data, such as scaling, color correction, artifact reduction, and encoding. The pipeline begins with the acquisition of raw image data from a sensor and concludes with the output of processed image data, which may be in a format suitable for viewing, printing, or further digital processing.

Within the context of this disclosure, the image processing pipeline specifically may include, but is not limited to, a PFA device (e.g., PFA device 102) that includes a detector device or module for identifying purple fringe artifacts based on a multifactor pixel-level analysis (e.g., detecting module 104), and an adjusting device or module for dynamically correcting identified artifacts based on a calculated confidence level that blends between different correction methods (e.g., adjusting module 106). The pipeline may further encompass preprocessing stages such as scaling, to adjust the resolution or size of the image data before artifact detection, and post-processing stages such as the application of a Color Correction Matrix (CCM), to adjust the color balance and accuracy of the image data after artifact correction.

The image processing pipeline is designed to operate efficiently within digital imaging systems, ensuring that the processed image data reflects enhancements and corrections that significantly improve visual quality and fidelity relative to the original raw data. This pipeline facilitates the automated correction of common imaging artifacts, including but not limited to purple fringing, thereby streamlining the post-capture processing of digital images and enhancing the overall user experience.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of the modules included in PFA device 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As shown in FIG. 1, memory 120 may include, store, maintain, access, or otherwise interact with image data 122. Image data 122 may include any digital information representing visual content captured or generated by one or more imaging devices, such as digital cameras, scanners, or computational algorithms. This data may consist of one or more matrices of pixels, where each pixel contains numerical values that represent the intensity and color of that point in the image. Image data can be in various formats, including, but not limited to, raw sensor data, bitmap images, and compressed formats like JPEG or PNG.

In the context of the present disclosure, image data may be processed through an image processing pipeline to detect and correct artifacts, specifically purple fringe artifacts. The term encompasses both the initial, unprocessed data directly obtained from the imaging sensor, often referred to as “raw” image data, and the data at any subsequent stage of processing within the pipeline. This includes data that has been scaled, color-corrected, or otherwise modified to enhance image quality or to prepare it for output and display.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules included in PFA device 102 and/or stored in memory 120. Additionally or alternatively, physical processor 130 may execute one or more of detecting module 104 and/or adjusting module 106 to facilitate purple fringe correction. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

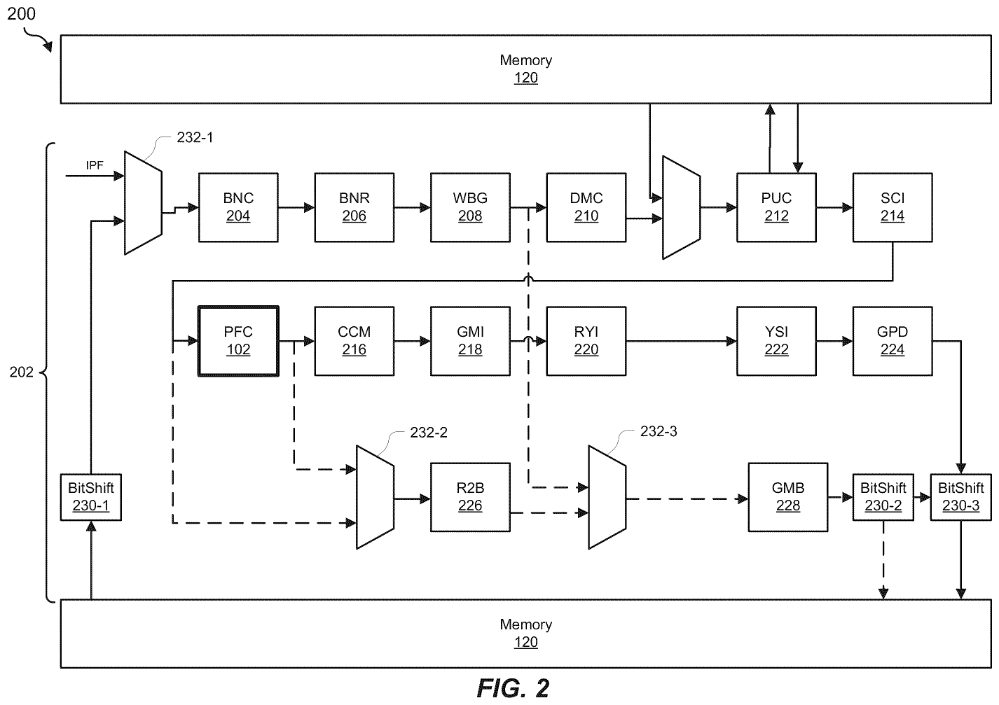

Example system 100 in FIG. 1 may be implemented in a variety of ways. For example, all or a portion of example system 100 may represent portions of an example system 200 (“system 200”) in FIG. 2. FIG. 2 also illustrates various operations or stages within an image processing pipeline 202, and a possible position or role of PFA device 102 therein. As shown, the illustrated image processing pipeline includes a binning correction and chromatic aberration correction operation (BNC 204), a Bayer noise reduction operation (BNR 206), a white balance gain operation (WBG 208), a demosaic operation (DMC 210), a pixel unclipping operation (PUC 212), and a scaler operation (SCI 214) that may execute earlier in the image processing pipeline than the operations of PFA device 102. Following the operations of PFA device 102, the image processing pipeline may include a color correction matrix operation (CCM 216), a gamma correction operation (GMI 218), a RGB to YUV operation (RYI 220), a chroma downscaler operation (YSI 222), and a Gaussian pyramid operation (GPD 224). A concurrent process withing image processing pipeline 202 may also include an RGB to Bayer operation (R2B 226) and a gamma correction operation (GMB 228). Image processing pipeline 202 may also include various bit shift operations 230 (e.g., bit shift 230-1, bit shift 230-2, and bit shift 230-3) and multiplexing operations (e.g., mux 232-1, mux 232-2, and 232-3) that may alter or combine data within image processing pipeline 202. For additional details regarding each of the foregoing operations, see the Appendices to the Provisional Application.

In at least one embodiment, one or more of the modules included in PFA device 102 from FIG. 1 may, when executed as part of image processing pipeline 202, may enable image processing pipeline 202 (and/or a computer device that executes image processing pipeline 202) to perform one or more operations to correct and/or adjust a purple fringe artifact included in image data. For example, as will be described in greater detail below, detecting module 104 may detect, based on a multifactor pixel-level analysis of the image data, that the image data includes at least one purple fringe artifact. Furthermore, adjusting module 106 may dynamically adjust, based on a calculated confidence level that blends between different correction methods, the image data to reduce a visual impact of the at least one purple fringe artifact.

Image processing pipeline 202 may be executed by any suitable computing device including any type or form of computing device capable of reading and/or executing computer-executable instructions. Examples of such computing devices include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

Many other devices or subsystems may be connected to system 100 in FIG. 1 and/or system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for purple fringe correction. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may detect, based on a multifactor pixel-level analysis of the image data, that the image data includes at least one purple fringe artifact. For example, detecting module 104 may, as part of image processing pipeline 202, detect, based on a multifactor pixel-level analysis of image data received from SCI 214, that the image data received from SCI 214 includes at least one purple fringe artifact.

Detecting module 104 may perform a multifactor pixel-level analysis on the image data. This multifactor analysis may encompass several computational steps designed to assess the likelihood that any given pixel is part of a purple fringe artifact. For example, detecting module 104 may perform a pixel neighborhood assessment, wherein detecting module 104 may evaluate each pixel within its surrounding pixel environment, typically using a predefined neighborhood size, such as a 7×7 matrix. This assessment considers the relative distances of neighboring pixels to the central pixel, contributing to a weighting factor that impacts subsequent analyses.

Additionally or alternatively, detecting module 104 may calculate an intensity similarity among pixels within the neighborhood. It may assess how closely the luminance values of surrounding pixels match the central pixel, with higher similarity increasing the likelihood of contributing to a purple fringe artifact.

Moreover, in some examples, detecting module 104 may examine the color information of each pixel, comparing it to a known profile of typical purple fringe colors. A color similarity metric may be derived, with pixels closely matching the characteristic purple fringe color receiving a higher weight in the detection process.

Utilizing the distance, intensity similarity, and color similarity data, detecting module 104 may generates a weighted average for the central pixel. This average may determine a degree to which each pixel is influenced by potential purple fringing, providing a basis for correction by downstream processing modules.

Detecting module 104 may employ parallel processing techniques to analyze various image data characteristics simultaneously, enhancing the speed and efficiency of the detection operation. These may include, without limitation, a proximity analysis, a gradient analysis, and/or a chromaticity analysis.

In a proximity analysis, detecting module 104 may analyze pixel proximity to intensity-saturated areas, which may be prone to purple fringing due to blooming effects. For gradient-based detection, detecting module 104 may use techniques like the Sobel operator to identify areas of high contrast, which are common sites for purple fringing. For a chromaticity analysis, detecting module 104 may transform RGB data into a chromaticity domain to analyze color distributions and isolate the characteristic hues associated with purple fringe artifacts.

Upon completing the foregoing multifactor pixel-level analysis, detecting module 104 may output a set of data for each pixel. This data may include a probability score or weight that indicates the presence of a purple fringe artifact and a confidence level for the detected artifact. This output may be utilized by adjusting module 106 in the pipeline, which may dynamically correct the identified artifacts based on the provided detection data.

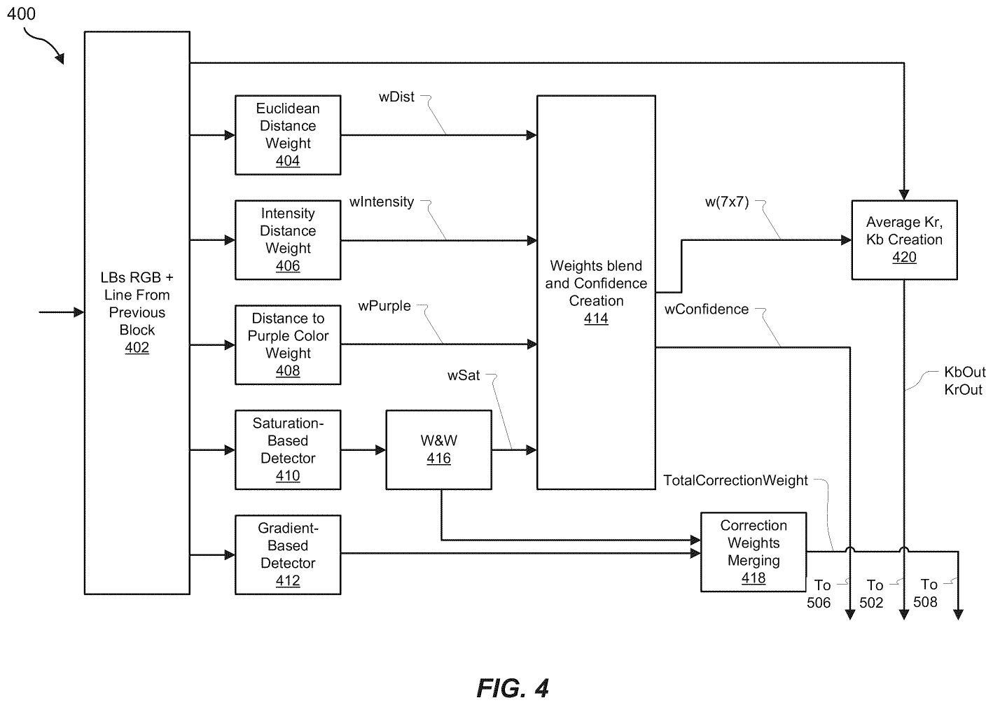

FIG. 4 illustrates a flow diagram 400 that details some of the specific operational steps carried out by the detecting module 104. The operational flow begins with input block 402, which receives line-buffered RGB (LBs RGB) image data from a previous block in the image processing pipeline. This data represents the image to be analyzed for purple fringe artifacts.

Block 404 computes a Euclidean Distance Weight for each pixel, which measures the spatial distance of surrounding pixels in relation to a central pixel in a given neighborhood, outputting a value denoted in FIG. 4 as “wDist.” This weight helps determine the likelihood that a pixel is part of a purple fringe artifact based on spatial proximity.

Following block 404, block 406 calculates an Intensity Distance Weight by comparing the intensity (or luminance) of each pixel to that of the central pixel. This weight, denoted in FIG. 4 as “wIntensity,” assesses whether nearby pixels have similar intensity values, which is indicative of potential purple fringing.

Block 408 is responsible for calculating the Distance to Purple Color Weight. This step involves determining a weight indicating how close the color of each pixel is to the typical color seen in purple fringe artifacts. Denoted in FIG. 4 as “wPurple,” a smaller distance increases the weight, signifying a higher probability of purple fringing.

Two parallel detection processes are carried out by saturation-based detector 410 and gradient-based detector 412. Saturation-based detector 410 examines the image data for regions of high saturation that may be prone to purple fringing. Gradient-based detector 412 analyzes the image data for high-contrast edges, which are common locations for purple fringe artifacts to occur.

Block 416, labeled W&W (Weights & Weights), receives input from the saturation-based detector 410 and assigns weights according to a distance to the nearest saturated pixel. Weights assigned for saturated pixels and near-saturated pixels may be lower than weights far from saturated pixels.

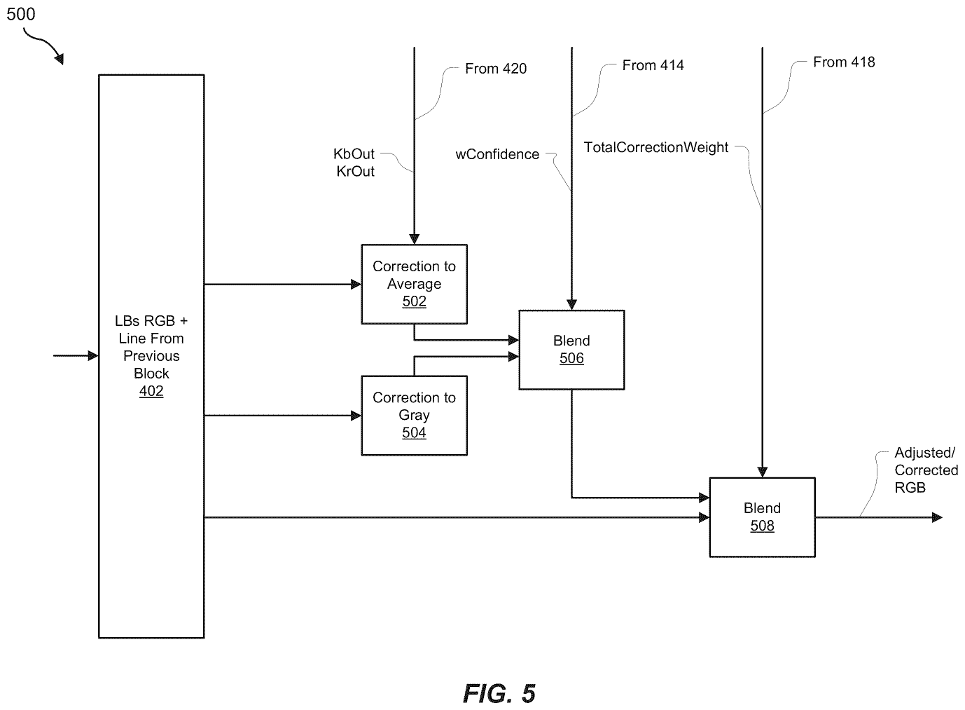

The weights generated by blocks 404, 406, 408, and the results from W&W block 416 converge at the Weights Blend and Confidence Creation block 414. This block integrates the various weights and formulates a confidence level (wConfidence in FIG. 4 and FIG. 5), reflecting the system's assurance in estimating the average Kr and Kb values in block 420.

Following the blending process, the Correction Weights Merging block 418 consolidates the weights to form a cohesive correction strategy for each pixel, outputting a “TotalCorrectionWeight” as shown in FIG. 4. Lastly, block 420, titled Average Kr and Kb Creation, utilizes the merged weights to calculate average values for the red (Kr) and blue (Kb) color channels. These calculated averages, denoted in FIG. 4 and FIG. 5 as “KbOut” and “KrOut,” are then used for the subsequent correction phases (e.g., in FIG. 5), where they inform the color adjustments needed to correct the detected purple fringe artifacts, ensuring the visual integrity of the image is upheld in the final output. Detecting module 104 may accomplish any of the foregoing operations in any of the ways disclosed herein.

Returning to FIG. 3, at step 320, one or more of the systems described herein may dynamically adjust, based on a calculated confidence level that blends between different correction methods, the image data to reduce a visual impact of the at least one purple fringe artifact. For example, adjusting module 106 may, as part of image processing pipeline 202, dynamically adjust image data to reduce a visual impact of the at least one purple fringe artifact.

Hence, adjusting module 106 may be responsible for purple fringe adjustment within the image processing pipeline. Adjusting module 106 may conduct per-pixel operations to correct identified purple fringe artifacts without necessitating additional line-buffers. The module may utilize two primary correction methods:

The first method involves the suppression of chrominance components. By comparing red (R) and blue (B) values to green (G), and employing a square coring function, the module adjusts R and B values towards G, effectively moving the pixel color towards gray, which is a state where R, G, and B values are equal. This technique helps mitigate the color distortion characteristic of purple fringing by desaturating the fringe color.

In some examples, a “square coring function” in image processing may include or refer to a type of nonlinear operation used to adjust the values of a signal—such as pixel intensity or color components—in a way that tends to suppress small variations while maintaining or enhancing larger ones. The term “coring” generally implies that values close to a certain threshold (often around zero) are pushed towards that threshold, effectively “coring out” small variations or noise. The “square” aspect typically means that the coring function involves squaring the input value as part of the processing, which can emphasize larger values over smaller ones.

In the context of color correction, a square coring function may be used to adjust chrominance values such that minor chromatic aberrations are reduced, while significant color differences are preserved or emphasized. This can help in reducing artifacts such as purple fringing by desaturating (pushing towards gray) those chrominance components that are not large enough to be deemed as intentional or significant color content of the image.

The second method corrects towards the average chrominance that has been estimated during the purple fringe detection phase. Using the same (or similar) square coring function, this method adjusts the chrominance values of the affected pixels to align with the average color of the surrounding area, thus reducing the prominence of the artifact.

Adjusting module 106 may additionally perform a blending of these two correction methods with the original pixel values. This blending may be controlled by two factors:

The label “wConfidence” corresponds to a dynamic parameter derived from the detector module that informs the degree of blending between the two correction methods—toward gray or average chrominance. A higher confidence level in the presence of purple fringing influences adjusting module 106 to rely more heavily on the corresponding correction method.

The label “TotalCorrectionWeight” corresponds to a value that is used to balance the blending of the corrected pixel value with the original pixel value. This ensures that the correction is subtle and consistent with the overall image, maintaining natural color gradations and avoiding abrupt transitions that could degrade image quality.

By blending the correction methods with the original pixel value, Adjusting module 106 is able to produce an output pixel that has reduced visual impact from the purple fringe while preserving the integrity and continuity of the image. The module's parallel processing of the correction methods enhances efficiency, allowing real-time correction that is both effective and computationally economical. The result is a refined image where the purple fringe artifacts are adjusted seamlessly, contributing to an improved visual aesthetic and accurate color representation. Adjusting module 106 may perform any of these operations in any of the ways disclosed herein.

FIG. 5 illustrates flow diagram 500, showcasing the specific steps that adjusting module 106 executes for the correction of purple fringe artifacts in digital image data. This flow diagram is interconnected with elements from FIG. 4, depicting a cohesive operation within the image processing pipeline.

The operational flow begins with input block 402 which, as in FIG. 4, receives line-buffered RGB (LBs RGB) image data from a previous block in the image processing pipeline. This data represents the image to be analyzed for purple fringe artifacts.

In block 502, titled “Correction to Average,” adjusting module 106 uses the average chrominance values, provided from block 420 in FIG. 4, to adjust the color of the pixels that have been identified as containing purple fringe artifacts, aligning them with the average color of the adjacent pixels to reduce the visual impact of the artifacts.

Simultaneously, in block 504, labeled “Correction to Gray,” adjusting module 106 works on the same set of identified pixels but adopts a different correction strategy. Here, it suppresses the chrominance towards gray, aiming to neutralize the purple fringe by equalizing the R, G, and B values of the affected pixels.

Following these correction paths, the results are then routed to block 506, “Blend,” where the outputs of the “Correction to Average” and “Correction to Gray” are blended together. This blending is influenced by the confidence levels and weights received from block 414 and block 418 of FIG. 4, ensuring that the blend is optimized for each pixel based on the severity and confidence of the artifact's detection.

The final blending operation takes place in block 508, where the corrected pixel values from block 506 are seamlessly integrated with the original image data. This final blend ensures that the corrections do not disrupt the overall continuity of the image, preserving natural colors and image details while effectively mitigating the appearance of any purple fringe artifacts.

The output from block 508 represents the corrected image data, which has now been processed to reduce the presence of purple fringing, enhancing the visual quality of the final image. Flow diagram 500, in conjunction with the referenced elements from FIG. 4, conveys a systematic and precise approach to purple fringe correction employed by adjusting module 106, highlighting the module's capability to deliver high-fidelity image correction in a digital imaging system. As noted above, adjusting module 106 may execute any of the foregoing operations in any of the ways disclosed herein.

As may be clear from the foregoing description, embodiments of this disclosure have many benefits over conventional options for reducing purple fringe artifacts. As described above, some embodiments may include a multifactor pixel-level analysis and dynamic adjustment strategies within the image processing pipeline, ensuring precise artifact identification and nuanced correction.

Additional innovative elements such as parallel detection processes and the use of square coring functions may allow for a sophisticated correction that blends seamlessly with the original image data. This approach not only automates the correction process, reducing the need for manual post-processing, but also maintains image integrity. Hence, embodiments of the systems and methods disclosed herein offer significant benefits in digital image processing, streamlining workflows, and enhancing image quality, which is pivotal across various imaging applications. Embodiments may be particularly useful in improving user experiences in VR/AR applications.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

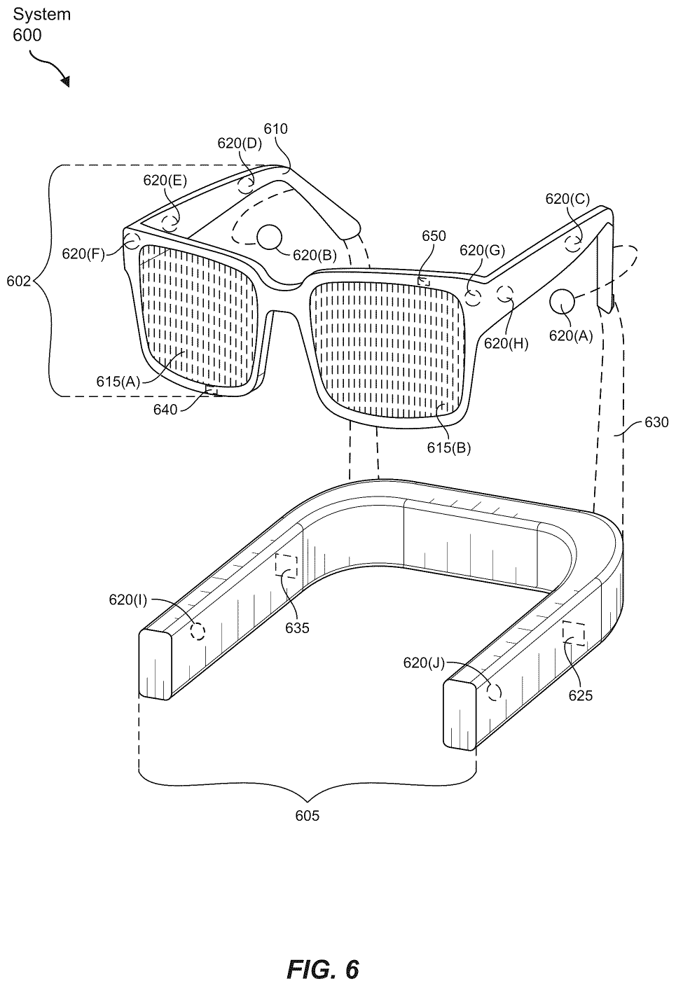

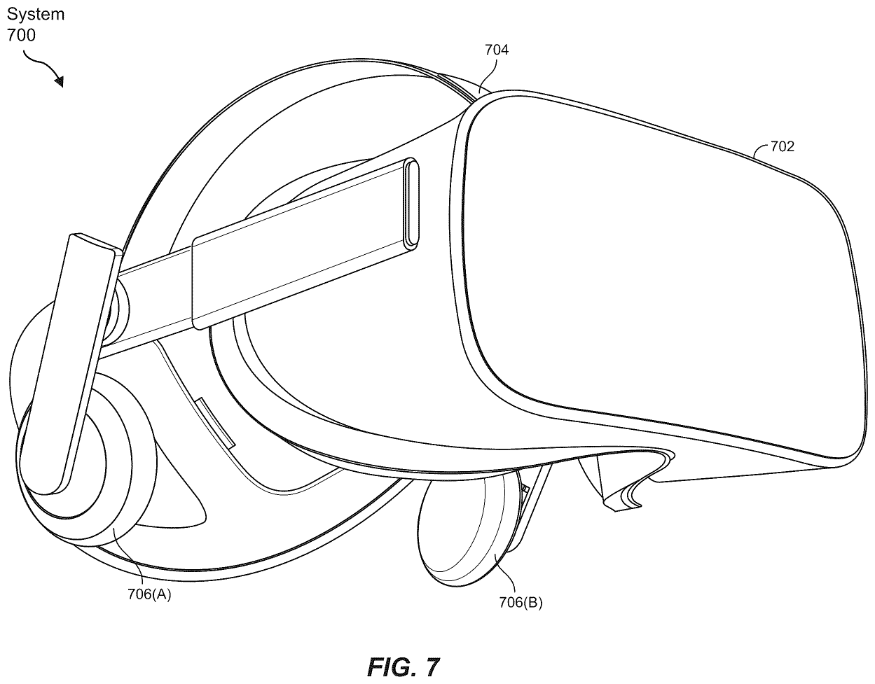

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 600 in FIG. 6) or that visually immerses a user in an artificial reality (such as, e.g., virtual-reality system 700 in FIG. 7).

While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality system 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium-ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment.

Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 600 and 700 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

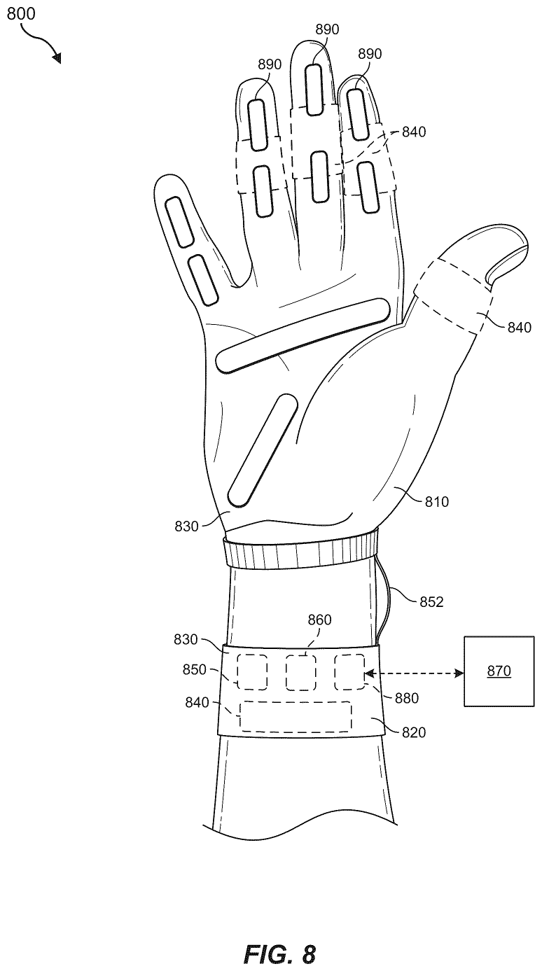

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 8 illustrates a vibrotactile system 800 in the form of a wearable glove (haptic device 810) and wristband (haptic device 820). Haptic device 810 and haptic device 820 are shown as examples of wearable devices that include a flexible, wearable textile material 830 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 840 may be positioned at least partially within one or more corresponding pockets formed in textile material 830 of vibrotactile system 800. Vibrotactile devices 840 may be positioned in locations to provide a vibrating sensation (e.g., haptic feedback) to a user of vibrotactile system 800. For example, vibrotactile devices 840 may be positioned against the user's finger(s), thumb, or wrist, as shown in FIG. 8. Vibrotactile devices 840 may, in some examples, be sufficiently flexible to conform to or bend with the user's corresponding body part(s).

A power source 850 (e.g., a battery) for applying a voltage to the vibrotactile devices 840 for activation thereof may be electrically coupled to vibrotactile devices 840, such as via conductive wiring 852. In some examples, each of vibrotactile devices 840 may be independently electrically coupled to power source 850 for individual activation. In some embodiments, a processor 860 may be operatively coupled to power source 850 and configured (e.g., programmed) to control activation of vibrotactile devices 840.

Vibrotactile system 800 may be implemented in a variety of ways. In some examples, vibrotactile system 800 may be a standalone system with integral subsystems and components for operation independent of other devices and systems. As another example, vibrotactile system 800 may be configured for interaction with another device or system 870. For example, vibrotactile system 800 may, in some examples, include a communications interface 880 for receiving and/or sending signals to the other device or system 870. The other device or system 870 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 880 may enable communications between vibrotactile system 800 and the other device or system 870 via a wireless (e.g., Wi-Fi, BLUETOOTH, cellular, radio, etc.)

link or a wired link. If present, communications interface 880 may be in communication with processor 860, such as to provide a signal to processor 860 to activate or deactivate one or more of the vibrotactile devices 840.

Vibrotactile system 800 may optionally include other subsystems and components, such as touch-sensitive pads 890, pressure sensors, motion sensors, position sensors, lighting elements, and/or user interface elements (e.g., an on/off button, a vibration control element, etc.). During use, vibrotactile devices 840 may be configured to be activated for a variety of different reasons, such as in response to the user's interaction with user interface elements, a signal from the motion or position sensors, a signal from the touch-sensitive pads 890, a signal from the pressure sensors, a signal from the other device or system 870, etc.

Although power source 850, processor 860, and communications interface 880 are illustrated in FIG. 8 as being positioned in haptic device 820, the present disclosure is not so limited. For example, one or more of power source 850, processor 860, or communications interface 880 may be positioned within haptic device 810 or within another wearable textile.

Haptic wearables, such as those shown in and described in connection with FIG. 8, may be implemented in a variety of types of artificial-reality systems and environments.

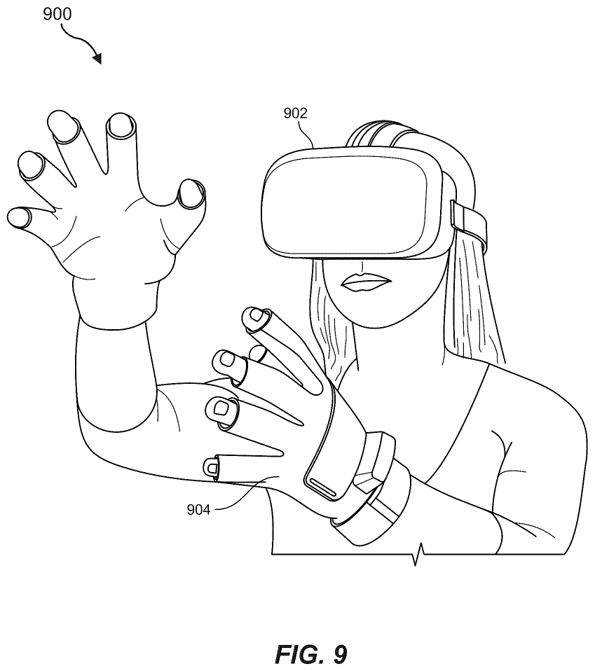

FIG. 9 shows an example artificial-reality environment 900 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 902 generally represents any type or form of virtual-reality system, such as virtual-reality system 700 in FIG. 7. Haptic device 904 generally represents any type or form of wearable device, worn by a user of an artificial-reality system, that provides haptic feedback to the user to give the user the perception that he or she is physically engaging with a virtual object. In some embodiments, haptic device 904 may provide haptic feedback by applying vibration, motion, and/or force to the user. For example, haptic device 904 may limit or augment a user's movement. To give a specific example, haptic device 904 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 904 to send action requests to a console. Examples of action requests include, without limitation, requests to start an application and/or end the application and/or requests to perform a particular action within the application.

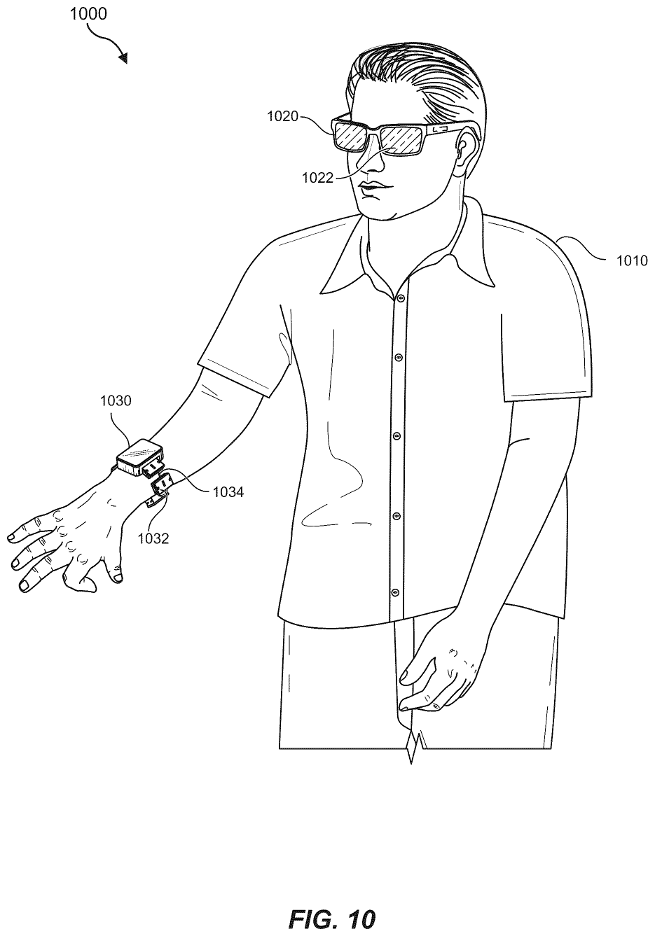

While haptic interfaces may be used with virtual-reality systems, as shown in FIG. 9, haptic interfaces may also be used with augmented-reality systems, as shown in FIG. 10. FIG. 10 is a perspective view of a user 1010 interacting with an augmented-reality system 1000. In this example, user 1010 may wear a pair of augmented-reality glasses 1020 that may have one or more displays 1022 and that are paired with a haptic device 1030. In this example, haptic device 1030 may be a wristband that includes a plurality of band elements 1032 and a tensioning mechanism 1034 that connects band elements 1032 to one another.

One or more of band elements 1032 may include any type or form of actuator suitable for providing haptic feedback. For example, one or more of band elements 1032 may be configured to provide one or more of various types of cutaneous feedback, including vibration, force, traction, texture, and/or temperature. To provide such feedback, band elements 1032 may include one or more of various types of actuators. In one example, each of band elements 1032 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 810, 820, 904, and 1030 may include any suitable number and/or type of haptic transducer, sensor, and/or feedback mechanism. For example, haptic devices 810, 820, 904, and 1030 may include one or more mechanical transducers, piezoelectric transducers, and/or fluidic transducers. Haptic devices 810, 820, 904, and 1030 may also include various combinations of different types and forms of transducers that work together or independently to enhance a user's artificial-reality experience. In one example, each of band elements 1032 of haptic device 1030 may include a vibrotactor (e.g., a vibrotactile actuator) configured to vibrate in unison or independently to provide one or more of various types of haptic sensations to a user.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

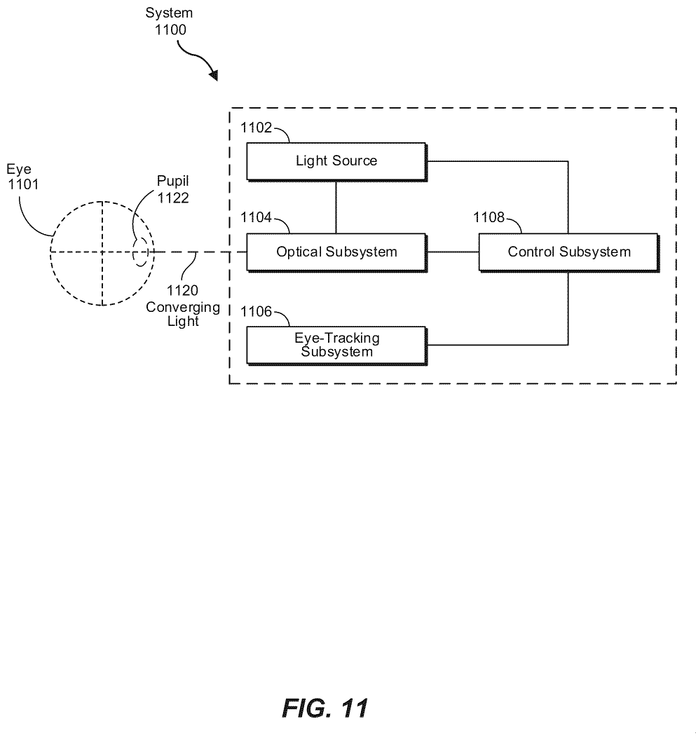

FIG. 11 is an illustration of an exemplary system 1100 that incorporates an eye-tracking subsystem capable of tracking a user's eye(s). As depicted in FIG. 11, system 1100 may include a light source 1102, an optical subsystem 1104, an eye-tracking subsystem 1106, and/or a control subsystem 1108. In some examples, light source 1102 may generate light for an image (e.g., to be presented to an eye 1101 of the viewer). Light source 1102 may represent any of a variety of suitable devices. For example, light source 1102 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1104 may receive the light generated by light source 1102 and generate, based on the received light, converging light 1120 that includes the image. In some examples, optical subsystem 1104 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1120. Further, various mechanical couplings may serve to maintain the relative spacing and/or the orientation of the optical components in any suitable combination.

In one embodiment, eye-tracking subsystem 1106 may generate tracking information indicating a gaze angle of an eye 1101 of the viewer. In this embodiment, control subsystem 1108 may control aspects of optical subsystem 1104 (e.g., the angle of incidence of converging light 1120) based at least in part on this tracking information. Additionally, in some examples, control subsystem 1108 may store and utilize historical tracking information (e.g., a history of the tracking information over a given duration, such as the previous second or fraction thereof) to anticipate the gaze angle of eye 1101 (e.g., an angle between the visual axis and the anatomical axis of eye 1101). In some embodiments, eye-tracking subsystem 1106 may detect radiation emanating from some portion of eye 1101 (e.g., the cornea, the iris, the pupil, or the like) to determine the current gaze angle of eye 1101. In other examples, eye-tracking subsystem 1106 may employ a wavefront sensor to track the current location of the pupil.

Any number of techniques can be used to track eye 1101. Some techniques may involve illuminating eye 1101 with infrared light and measuring reflections with at least one optical sensor that is tuned to be sensitive to the infrared light. Information about how the infrared light is reflected from eye 1101 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1106 may be digitized (i.e., converted to an electronic signal). Further, the sensor may transmit a digital representation of this electronic signal to one or more processors (for example, processors associated with a device including eye-tracking subsystem 1106). Eye-tracking subsystem 1106 may include any of a variety of sensors in a variety of different configurations. For example, eye-tracking subsystem 1106 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1106 to track the movement of eye 1101. In another example, these processors may track the movements of eye 1101 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1106 may be programmed to use an output of the sensor(s) to track movement of eye 1101. In some embodiments, eye-tracking subsystem 1106 may analyze the digital representation generated by the sensors to extract eye rotation information from changes in reflections. In one embodiment, eye-tracking subsystem 1106 may use corneal reflections or glints (also known as Purkinje images) and/or the center of the eye's pupil 1122 as features to track over time.

In some embodiments, eye-tracking subsystem 1106 may use the center of the eye's pupil 1122 and infrared or near-infrared, non-collimated light to create corneal reflections. In these embodiments, eye-tracking subsystem 1106 may use the vector between the center of the eye's pupil 1122 and the corneal reflections to compute the gaze direction of eye 1101. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1106 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1101 may act as a retroreflector as the light reflects off the retina, thereby creating a bright pupil effect similar to a red-eye effect in photography. If the illumination source is offset from the optical path, then the eye's pupil 1122 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1108 may control light source 1102 and/or optical subsystem 1104 to reduce optical aberrations (e.g., chromatic aberrations and/or monochromatic aberrations) of the image that may be caused by or influenced by eye 1101. In some examples, as mentioned above, control subsystem 1108 may use the tracking information from eye-tracking subsystem 1106 to perform such control. For example, in controlling light source 1102, control subsystem 1108 may alter the light generated by light source 1102 (e.g., by way of image rendering) to modify (e.g., pre-distort) the image so that the aberration of the image caused by eye 1101 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

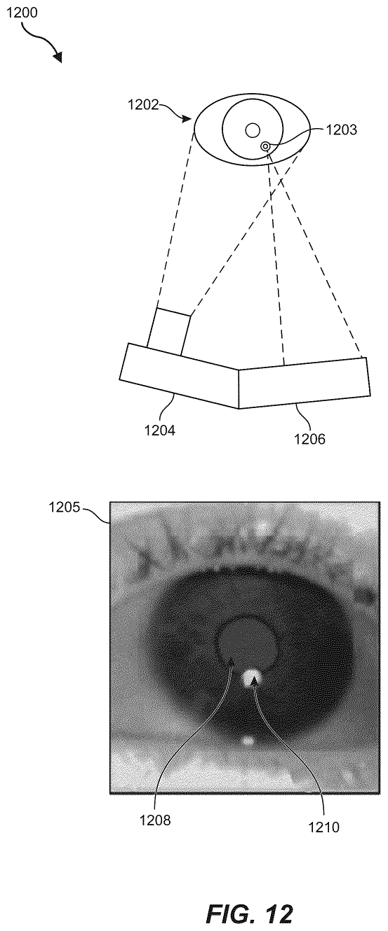

FIG. 12 is a more detailed illustration of various aspects of the eye-tracking subsystem illustrated in FIG. 11. As shown in this figure, an eye-tracking subsystem 1200 may include at least one source 1204 and at least one sensor 1206. Source 1204 generally represents any type or form of element capable of emitting radiation. In one example, source 1204 may generate visible, infrared, and/or near-infrared radiation. In some examples, source 1204 may radiate non-collimated infrared and/or near-infrared portions of the electromagnetic spectrum towards an eye 1202 of a user. Source 1204 may utilize a variety of sampling rates and speeds. For example, the disclosed systems may use sources with higher sampling rates in order to capture fixational eye movements of a user's eye 1202 and/or to correctly measure saccade dynamics of the user's eye 1202. As noted above, any type or form of eye-tracking technique may be used to track the user's eye 1202, including optical-based eye-tracking techniques, ultrasound-based eye-tracking techniques, etc.

Sensor 1206 generally represents any type or form of element capable of detecting radiation, such as radiation reflected off the user's eye 1202. Examples of sensor 1206 include, without limitation, a charge coupled device (CCD), a photodiode array, a complementary metal-oxide-semiconductor (CMOS) based sensor device, and/or the like. In one example, sensor 1206 may represent a sensor having predetermined parameters, including, but not limited to, a dynamic resolution range, linearity, and/or other characteristic selected and/or designed specifically for eye tracking.

As detailed above, eye-tracking subsystem 1200 may generate one or more glints. As detailed above, a glint 1203 may represent reflections of radiation (e.g., infrared radiation from an infrared source, such as source 1204) from the structure of the user's eye. In various embodiments, glint 1203 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 12 shows an example image 1205 captured by an eye-tracking subsystem, such as eye-tracking subsystem 1200. In this example, image 1205 may include both the user's pupil 1208 and a glint 1210 near the same. In some examples, pupil 1208 and/or glint 1210 may be identified using an artificial-intelligence-based algorithm, such as a computer-vision-based algorithm. In one embodiment, image 1205 may represent a single frame in a series of frames that may be analyzed continuously in order to track the eye 1202 of the user. Further, pupil 1208 and/or glint 1210 may be tracked over a period of time to determine a user's gaze.

In one example, eye-tracking subsystem 1200 may be configured to identify and measure the inter-pupillary distance (IPD) of a user. In some embodiments, eye-tracking subsystem 1200 may measure and/or calculate the IPD of the user while the user is wearing the artificial reality system. In these embodiments, eye-tracking subsystem 1200 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1100 and/or eye-tracking subsystem 1200 may be incorporated into augmented-reality system 600 in FIG. 6 and/or virtual-reality system 700 in FIG. 7 to enable these systems to perform various eye-tracking tasks (including one or more of the eye-tracking operations described herein).

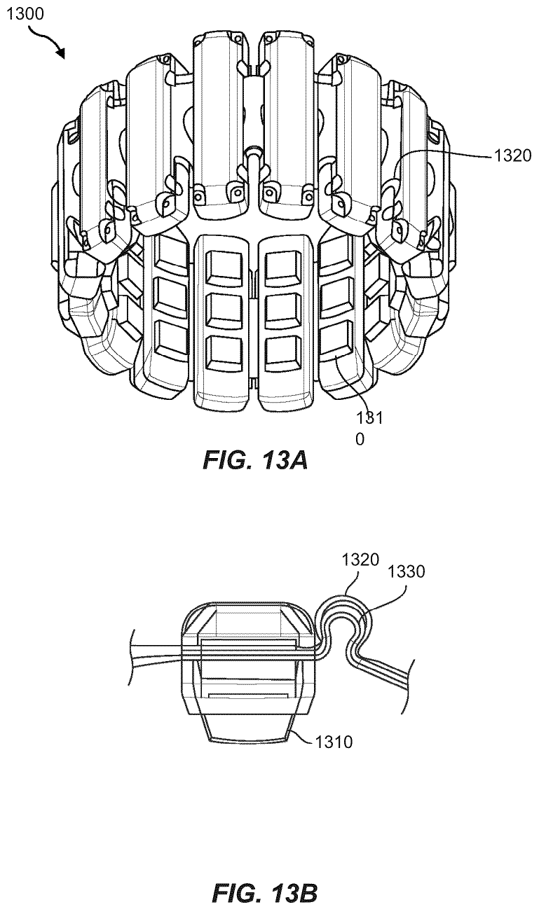

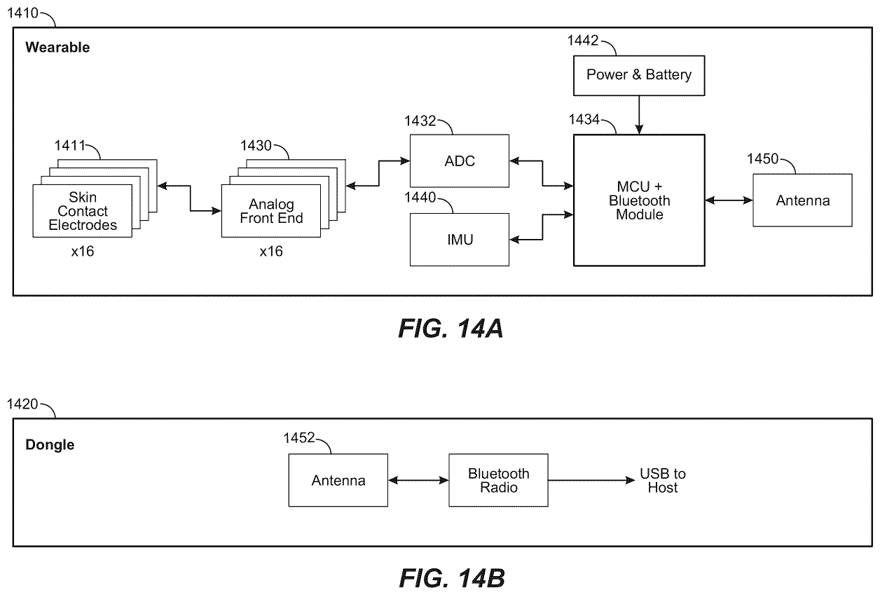

FIG. 13A illustrates an exemplary human-machine interface (also referred to herein as an EMG control interface) configured to be worn around a user's lower arm or wrist as a wearable system 1300. In this example, wearable system 1300 may include sixteen neuromuscular sensors 1310 (e.g., EMG sensors) arranged circumferentially around an elastic band 1320 with an interior surface 1330 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 13B illustrates a cross-sectional view through one of the sensors of the wearable device shown in FIG. 13A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1310 is discussed in more detail below with reference to FIGS. 14A and 14B.

FIGS. 14A and 14B illustrate an exemplary schematic diagram with internal components of a wearable system with EMG sensors. As shown, the wearable system may include a wearable portion 1410 (FIG. 14A) and a dongle portion 1420 (FIG. 14B) in communication with the wearable portion 1410 (e.g., via BLUETOOTH or another suitable wireless communication technology). As shown in FIG. 14A, the wearable portion 1410 may include skin contact electrodes 1411, examples of which are described in connection with FIGS. 13A and 13B. The output of the skin contact electrodes 1411 may be provided to analog front end 1430, which may be configured to perform analog processing (e.g., amplification, noise reduction, filtering, etc.) on the recorded signals. The processed analog signals may then be provided to analog-to-digital converter 1432, which may convert the analog signals to digital signals that can be processed by one or more computer processors. An example of a computer processor that may be used in accordance with some embodiments is microcontroller (MCU) 1434, illustrated in FIG. 14A. As shown, MCU 1434 may also include inputs from other sensors (e.g., IMU sensor 1440), and power and battery module 1442. The output of the processing performed by MCU 1434 may be provided to antenna 1450 for transmission to dongle portion 1420 shown in FIG. 14B.

Dongle portion 1420 may include antenna 1452, which may be configured to communicate with antenna 1450 included as part of wearable portion 1410. Communication between antennas 1450 and 1452 may occur using any suitable wireless technology and protocol, non-limiting examples of which include radiofrequency signaling and BLUETOOTH. As shown, the signals received by antenna 1452 of dongle portion 1420 may be provided to a host computer for further processing, display, and/or for effecting control of a particular physical or virtual object or objects.

Although the examples provided with reference to FIGS. 13A-13B and FIGS. 14A-14B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors.

The techniques described herein for reducing electromagnetic interference can also be implemented in wearable interfaces that communicate with computer hosts through wires and cables (e.g., USB cables, optical fiber cables, etc.).

The following example embodiments are also included in this disclosure:

Example 1: A method comprising (1) detecting, within an image processing pipeline, based on a multifactor pixel-level analysis of image data processed by the image processing pipeline, that the image data includes at least one purple fringe artifact, and (2) dynamically adjusting, within the image processing pipeline and based on a calculated confidence level that blends between different correction methods, the image data to reduce a visual impact of the at least one purple fringe artifact.

Example 2: The method of example 1, wherein the multifactor pixel-level analysis comprises assessing a distance of each pixel in a neighborhood from a central pixel to determine a presence of the at least one purple fringe artifact.

Example 3: The method any of examples 1-2, wherein the multifactor pixel-level analysis comprises evaluating pixel intensity similarity within a predefined pixel patch to detect the at least one purple fringe artifact.

Example 4: The method of any of examples 1-3, wherein the multifactor pixel-level analysis further comprises calculating color similarity to a predetermined purple artifact color profile to identify the at least one purple fringe artifact.

Example 5: The method of any of examples 1-4, wherein detecting that the image data includes the at least one purple fringe artifact comprises generating a weighted average based on factors comprising at least one of (1) a distance from a central pixel, (2) a pixel intensity similarity, or (3) a color similarity to a predefined typical purple artifact.

Example 6: The method of any of examples 1-5, wherein the multifactor pixel-level analysis of image data processed by the image processing pipeline comprises a plurality of parallel detection processes, each configured to analyze different characteristics of the image data to detect the at least one purple fringe artifact.

Example 7: The method of example 6, wherein at least one of the plurality of parallel detection processes comprises detecting proximity to intensity-saturated areas as an indicator of the at least one purple fringe artifact.

Example 8: The method of any of examples 6-7, wherein at least one of the plurality of parallel detection processes comprises a gradient-based detection mechanism that utilizes normalized derivatives to identify areas of high contrast indicative of the at least one purple fringe artifact.

Example 9: The method of any of examples 6-8, wherein at least one of the plurality of parallel detection processes comprises analyzing chromaticity domains to assess color similarity to typical purple fringe artifacts.

Example 10: A device comprising (1) a detector module, included in an image processing pipeline, that detects, based on a multifactor pixel-level analysis of image data processed by the image processing pipeline, that the image data includes at least one purple fringe artifact, and (2) an adjusting module that dynamically adjusts, within the image processing pipeline and based on a calculated confidence level that blends between different correction methods, the image data to reduce a visual impact of the at least one purple fringe artifact.

Example 11: The device of example 10, wherein the multifactor pixel-level analysis comprises assessing a distance of each pixel in a neighborhood from a central pixel to determine a presence of the at least one purple fringe artifact.

Example 12: The device of any of examples 10-11, wherein the multifactor pixel-level analysis comprises evaluating pixel intensity similarity within a predefined pixel patch to detect the at least one purple fringe artifact.

Example 13: The device of any of examples 10-12, wherein the multifactor pixel-level analysis further comprises calculating color similarity to a predetermined purple artifact color profile to identify the at least one purple fringe artifact.

Example 14: The device of any of examples 10-13, wherein the detector module detects that the image data includes the at least one purple fringe artifact by generating a weighted average based on factors comprising at least one of (1) a distance from a central pixel, (2) a pixel intensity similarity, or (3) a color similarity to a predefined typical purple artifact.

Example 15: The device of any of examples 10-14, wherein the multifactor pixel-level analysis of image data processed by the image processing pipeline comprises a plurality of parallel detection processes, each configured to analyze different characteristics of the image data to detect the at least one purple fringe artifact.

Example 16: The device of example 15, wherein the plurality of parallel detection processes comprises at least one of (1) detecting proximity to intensity-saturated areas as an indicator of the at least one purple fringe artifact, (2) a gradient-based detection mechanism that utilizes normalized derivatives to identify areas of high contrast indicative of the at least one purple fringe artifact, or (3) analyzing chromaticity domains to assess color similarity to typical purple fringe artifacts.

Example 17: A system comprising (1) a memory device that maintains image data, (2) an image processing pipeline comprising a purple fringe adjusting device comprising (A) a detector module that detects, based on a multifactor pixel-level analysis of the image data, that the image data includes at least one purple fringe artifact, and (B) an adjusting module that dynamically adjusts, based on a calculated confidence level that blends between different correction methods, the image data to reduce a visual impact of the at least one purple fringe artifact.

Example 18: The system of example 17, wherein the image processing pipeline further comprises (1) a scaler device that scales image data prior to the detector device detecting that the image data includes at least one purple fringe artifact, and (2) a color correction matrix that further adjusts color data included in the image data after the adjusting device dynamically adjusts the image data to reduce the visual impact of the at least one purple fringe artifact.

Example 19: The system of any of examples 17-18, wherein the detector module detects that the image data includes the at least one purple fringe artifact by generating a weighted average based on factors comprising at least two of (1) a distance from a central pixel, (2) a pixel intensity similarity, or (3) a color similarity to a predefined typical purple artifact.

Example 20: The system of any of examples 17-19, wherein (1) the multifactor pixel-level analysis of image data processed by the image processing pipeline comprises a plurality of parallel detection processes, each configured to analyze different characteristics of the image data to detect the at least one purple fringe artifact, (2) the plurality of parallel detection processes comprises at least two of (A) detecting proximity to intensity-saturated areas as an indicator of the at least one purple fringe artifact, (B) a gradient-based detection mechanism that utilizes normalized derivatives to identify areas of high contrast indicative of the at least one purple fringe artifact, or (C) analyzing chromaticity domains to assess color similarity to typical purple fringe artifacts.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data, output a result of the transformation to display corrected or adjusted image data, use the result of the transformation to display the corrected or adjusted image data, and store the result of the transformation to correct or adjust further image data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
detecting, within an image processing pipeline, based on a multifactor pixel-level analysis of image data processed by the image processing pipeline, that the image data includes at least one purple fringe artifact; and
dynamically adjusting, within the image processing pipeline and based on a calculated confidence level that blends between different correction methods, the image data to reduce a visual impact of the at least one purple fringe artifact.

2. The method of claim 1, wherein the multifactor pixel-level analysis comprises assessing a distance of each pixel in a neighborhood from a central pixel to determine a presence of the at least one purple fringe artifact.

3. The method of claim 1, wherein the multifactor pixel-level analysis comprises evaluating pixel intensity similarity within a predefined pixel patch to detect the at least one purple fringe artifact.

4. The method of claim 1, wherein the multifactor pixel-level analysis further comprises calculating color similarity to a predetermined purple artifact color profile to identify the at least one purple fringe artifact.

5. The method of claim 1, wherein detecting that the image data includes the at least one purple fringe artifact comprises generating a weighted average based on factors comprising at least one of:
a distance from a central pixel,
a pixel intensity similarity, or
a color similarity to a predefined typical purple artifact.

6. The method of claim 1, wherein the multifactor pixel-level analysis of image data processed by the image processing pipeline comprises a plurality of parallel detection processes, each configured to analyze different characteristics of the image data to detect the at least one purple fringe artifact.

7. The method of claim 6, wherein at least one of the plurality of parallel detection processes comprises detecting proximity to intensity-saturated areas as an indicator of the at least one purple fringe artifact.

8. The method of claim 6, wherein at least one of the plurality of parallel detection processes comprises a gradient-based detection mechanism that utilizes normalized derivatives to identify areas of high contrast indicative of the at least one purple fringe artifact.

9. The method of claim 6, wherein at least one of the plurality of parallel detection processes comprises analyzing chromaticity domains to assess color similarity to typical purple fringe artifacts.

10. A device comprising:
a detecting module, included in an image processing pipeline, that detects, based on a multifactor pixel-level analysis of image data processed by the image processing pipeline, that the image data includes at least one purple fringe artifact; and
an adjusting module that dynamically adjusts, within the image processing pipeline and based on a calculated confidence level that blends between different correction methods, the image data to reduce a visual impact of the at least one purple fringe artifact.

11. The device of claim 10, wherein the multifactor pixel-level analysis comprises assessing a distance of each pixel in a neighborhood from a central pixel to determine a presence of the at least one purple fringe artifact.

12. The device of claim 10, wherein the multifactor pixel-level analysis comprises evaluating pixel intensity similarity within a predefined pixel patch to detect the at least one purple fringe artifact.

13. The device of claim 10, wherein the multifactor pixel-level analysis further comprises calculating color similarity to a predetermined purple artifact color profile to identify the at least one purple fringe artifact.

14. The device of claim 10, wherein the detecting module detects that the image data includes the at least one purple fringe artifact by generating a weighted average based on factors comprising at least one of:
a distance from a central pixel,
a pixel intensity similarity, or
a color similarity to a predefined typical purple artifact.

15. The device of claim 10, wherein the multifactor pixel-level analysis of image data processed by the image processing pipeline comprises a plurality of parallel detection processes, each configured to analyze different characteristics of the image data to detect the at least one purple fringe artifact.

16. The device of claim 15, wherein the plurality of parallel detection processes comprises at least one of:
detecting proximity to intensity-saturated areas as an indicator of the at least one purple fringe artifact;
a gradient-based detection mechanism that utilizes normalized derivatives to identify areas of high contrast indicative of the at least one purple fringe artifact; or
analyzing chromaticity domains to assess color similarity to typical purple fringe artifacts.

17. A system comprising:
a memory device that maintains image data;
an image processing pipeline comprising a purple fringe adjusting device comprising:
a detecting module that detects, based on a multifactor pixel-level analysis of the image data, that the image data includes at least one purple fringe artifact; and
an adjusting module that dynamically adjusts, based on a calculated confidence level that blends between different correction methods, the image data to reduce a visual impact of the at least one purple fringe artifact.

18. The system of claim 17, wherein the image processing pipeline further comprises:
a scaler device that scales image data prior to the detecting module detecting that the image data includes at least one purple fringe artifact; and
a color correction matrix that further adjusts color data included in the image data after the adjusting module dynamically adjusts the image data to reduce the visual impact of the at least one purple fringe artifact.

19. The system of claim 17, wherein the detecting module detects that the image data includes the at least one purple fringe artifact by generating a weighted average based on factors comprising at least two of:
a distance from a central pixel,
a pixel intensity similarity, or
a color similarity to a predefined typical purple artifact.

20. The system of claim 17, wherein:
the multifactor pixel-level analysis of image data processed by the image processing pipeline comprises a plurality of parallel detection processes, each configured to analyze different characteristics of the image data to detect the at least one purple fringe artifact;
the plurality of parallel detection processes comprises at least two of:
detecting proximity to intensity-saturated areas as an indicator of the at least one purple fringe artifact;
a gradient-based detection mechanism that utilizes normalized derivatives to identify areas of high contrast indicative of the at least one purple fringe artifact; or
analyzing chromaticity domains to assess color similarity to typical purple fringe artifacts.
